(19) United States
(12) Patent Application Publication
(10) Pub. No.: US 2004/0093200 A1
(43) Pub. Date: May 13, 2004

(54) Method of and system for recognizing concepts

(75) Inventor: Eric D. Scott, San Diego, CA (US)

Correspondence Address: Pillsbury Winthrop LLP, Intellectual Property Group, 11682 El Camino Real, Suite 200, San Diego, CA, 92130, US

(73) Assignee: Island Data Corporation, Carlsbad, CA

(21) Appl. No.: 10/290,957

(22) Filed: Nov. 7, 2002

(51) Int. Cl. G06F 9/44; G09B 19/00; G06F 17/27

(52) U.S. Cl. 704/9; 717/142; 434/236

(57) ABSTRACT

A concept recognition system includes a concept recognition training system and a real-time system. The concept recognition training system processes a training set and produces a lexical profile keyed to a target category. The lexical profile comprises a set of lexical cues, which are words and phrases associated with the target category. A trainer starts with an initial lexical profile that comprises a small set of seed cues. The training system retrieves samples from the training set that match lexical cues in the lexical profile. The trainer determines which of the retrieved samples are positive instances of the target category. The training system extracts lexical cues from the positive instances and adds new lexical cues to the lexical profile. The real-time system uses the lexical profile as the basis for making confidence judgments for each new incoming message from the same input stream with respect to whether the message is an instance of the target category.

### FIELD OF THE INVENTION

The present invention relates generally to the field of automated unstructured text categorization, and more particularly to a method of and system for recognizing concepts in unstructured raw text.

### BACKGROUND OF THE INVENTION

As various forms of on-line communications have become commonplace, businesses, governments, and organizations receive tremendous amounts of information. The advent of electronic mail has made it very easy for customers and other interested parties to communicate with organizations. Most organizations welcome and encourage their customers and members of the public in general to communicate with them. However, organizations are faced with the inability to provide resources to process that information. There is a need for an automated system for categorizing communications before they are routed to a human for response or other action.

Organizations are interested in what their customers have to say about the organization's products and services. Companies often engage in communications with customers that are structured, and allow processing and aggregation by simplistic means. The most common example is an on-line survey, which includes methods to select one or more pre-conceived answers to questions.

While interacting with a customer in this structured way has some value, the more important communication is when the customers are expressing themselves in their own words. When expressing themselves in their own words, customers are revealing more of what is important to them than in the case where they can only answer “True” or “False.”

There are systems that provide a level of analysis on raw text to derive meaning. Most such systems use a technique is referred to as “keyword” or “Boolean logic.” To apply this method, each unstructured text example is compared against a list of single or multi word phrases. If any one of this list of words or phrases is within the input text, then there is said to be a “match”, and any actions depending on a match are performed. For example, a keyword file may be written to look for words that denote the concept of “Urgency”. A keyword list that contains the word “ASAP” would be a match, and priority routing may be the resultant actions.

Keyword systems are entirely adequate in some domains. In some domains, any existence of a word is, by definition, a match. An example of this would be in the identification of emails that contain profane words. Keyword systems also have value in situations where simple concepts are being analyzed. The “Urgency” concept mentioned before is this type.

For situations where the concept is more complex, or more flexible conditions are required, a keyword system is not adequate. A more flexible scoring system is required, where a number is generated from the analysis. With this number, thresholds can be adjusted in real-time to meet the changing needs. For example, a possible concept to be analyzed for a stream of customer service emails to a printer manufacturer would be to search for interactions that indicated the customer was interested in buying products that are offered for sale at the company's on-line store. Often this entails buying ink cartridges, special photo quality paper, and other more obscure items such as ink waste tanks. A possible action of determining a match is to forward the email to an agent, who responds back to the customer with information on how to buy on-line. The result of such an interaction would likely be a lifetime customer of the on-line store.

With a Keyword system, there is little ability to change the system to reflect changes in capability. For example, a company may be normally staffed with 20 people to process sales leads from the above example. If the number of people processing leads declined to 10 people, it would be very difficult to adjust a keyword system to reduce the output.

A keyword-based system has a number of additional disadvantages for identifying human concepts within raw text interactions. To identify concepts, a number of different Boolean keyword attributes must be identified, then a complex combinations of these attributes must be combined to decide if the concept was true. For example, if the concept to be identified is “wants to buy consumable printer products”, possible keyword attributes would be to identify if the text contains items that are sold, general words that indicate desire to buy (with tense to buy, but not bought), absence of negative indications (negative tone, profanity, etc). To determine accurately if the concept was present, many of these attributes must be deduced, the words that drive the attribute must be deduced, and a sample needs to be audited to see how the assumptions need to be corrected.

Additionally, when modifications are made, such as adding some additional keywords to an attribute, many unintended consequences can result. In the end, a large amount of human effort is required to produce a system that is hard to optimize and is fragile. A keyword-based system is a bottom-up approach, which requires significant effort, deductive reasoning, and luck to achieve positive results.

Other score-based systems are common in the technical literature and in the marketplace. These systems also apply the basic methodology of producing a set of tokens and values via an off-line training process. This is a top down approach that does not require identification of the specific words, and the relationships among them, to process a result. However, these approaches are intensive in computation and in training. The training system uses only the final result of an interaction, and uses the statistical frequencies of the words in the training set to assign a score. Some systems required 50 MB of emails and significant time to train the system for email auto response.

### SUMMARY OF THE INVENTION

The present invention provides and trains a categorization engine that can be used in real-time to categorize by concept natural language messages taken from a stream of incoming messages. The system of the present invention includes a concept recognition training system and a real-time system. The concept recognition training system takes as input a representative sample of messages from the input stream, and produces as output a lexical profile keyed to a target category. The representative sample of messages forms a training set. The lexical profile is comprised of a set of lexical cues, which are words and phrases associated with the target category. The real-time system uses the lexical profile as the basis for making confidence judgments for each new incoming message from the same input stream with respect to whether the message is an instance of the target category. An example of a target category might, for example, be “attrition risk” where customers are informing the addressee of extreme dissatisfaction with their service, or “enhancement recommendations”, where customers are requesting that the addressee improve their product offering in some way.

According to the present invention, the concept recognition training system is operated by a trainer who may have little or no background in linguistics or statistics, but has a good sense of the language being used in the input stream and training set. The trainer uses the concept recognition training system reiteratively to administer the lexical profile and audit the training set. Administering the lexical profile involves first specifying one or more seed cues, which are words and phrases expected to be found in positive instances of the target category. The seed cues automatically retrieve samples from the training set for auditing. Auditing the training set involves reviewing the samples retrieved from the training set. The concept recognition training system provides a graphical user interface with which the trainer can quickly hand-categorize the sample as positive or negative instance of the target category.

After auditing, the concept recognition training system automatically extracts lexical cues from the positive instances. This automatic extraction involves determining words and phrases found in the set of positive instances with frequencies much greater than would be expected by chance. Each lexical cue is assigned a weight reflecting its strength of association with the target, assessed as the mutual information between the lexical cue and the target category within the training set. Thus the training set and the lexical profile inform each other, and the process reiterates between the two until the trainer is confident that the lexical profile is complete enough to recognize the target category acceptably well, at which time the trainer publishes the lexical profile.

The real-time system uses the published lexical profile as the basis for categorization of input text. The real-time system characterizes the input text on the basis of a weighted vector. The input text is then rated by a categorization algorithm with a score ranging from 0 to 100. This makes it easier for unsophisticated users to understand, and separates the application from the actual details of the classification algorithm used. The real-time system matches each item of text input against the lexical profile, applies a heuristic to extract some N of the most important statistically independent lexical cue instances in each sentence of the input, and derives a confidence score from the sum of their associated mutual information values. The sentence with the highest score is taken as the score for the whole message with respect to the target.

### BRIEF DESCRIPTION OF THE DRAWINGS

FIG. 1 is a block diagram of a system according to the present invention.

FIG. 2 is a flowchart of system training according to the present invention.

FIG. 3 is a flowchart of real-time categorization according to the present invention.

### DESCRIPTION OF THE PREFERRED EMBODIMENT

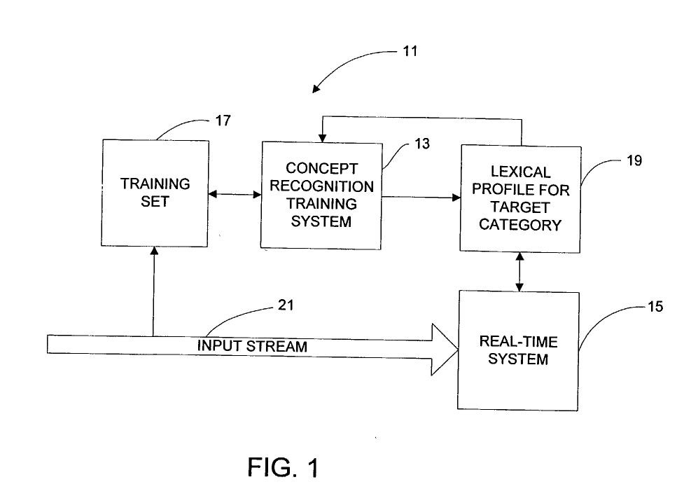

Referring now to the drawings, and first to FIG. 1, a concept recognition system according to the present invention is designated generally by the numeral 11. System 11 includes a concept recognition training system 13 and a real-time system 15. Concept recognition training system 13 is preferably implemented in a personal computer or workstation having a display and user input devices, such as a keyboard and a mouse, and an operating system that supports a graphical user interface. Real-time system 15 may be implemented in many computer environments, such as servers, mid range computers, or enterprise system computers.

According to the present invention, concept recognition training system 13 receives, as input, sample raw text items from a training set 17 and produces, as output, a lexical profile for a target category, indicated at 19. Training set 17 comprises a sample of at least partially unstructured text items selected at by the trainer from an input text stream 21. Input stream 21 may comprise e-mail items, text files, HTML files, scanned hard copy, or other electronic text files, as will be apparent to those skilled in the art. Real-time system 15 receives input stream 21 and uses lexical profile 19 to categorize the raw text. Real-time system 15 produces a score associated with the document that represents the documents correspondence with the target category.

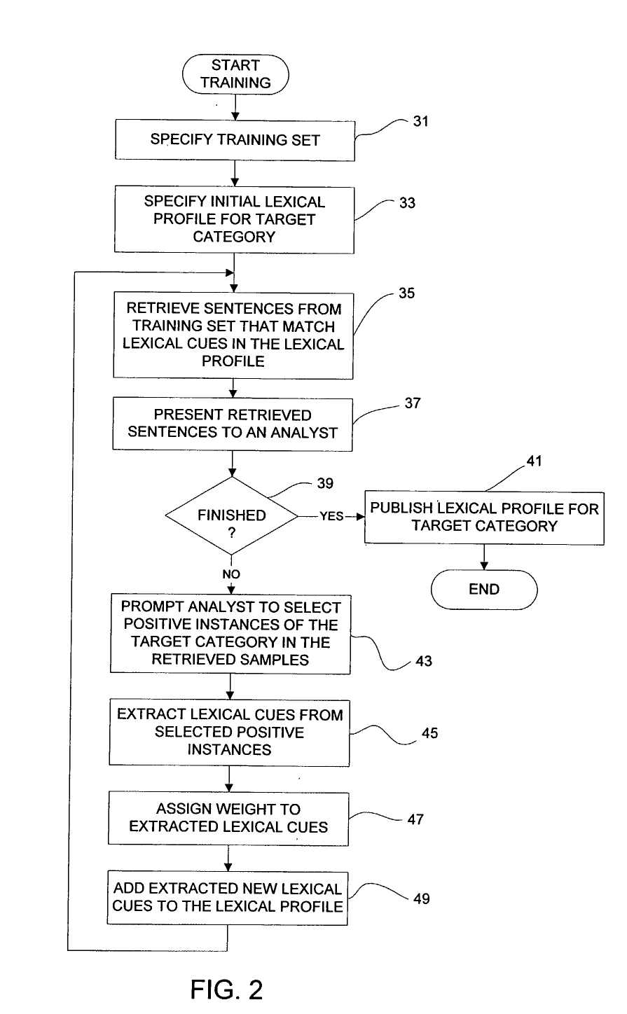

Referring now to FIG. 2, there is shown a flowchart of training performed with concept recognition training system 13 according to the present invention. A training set is specified at block 31. Again, the training set comprises a representative sample of documents to be categorized according to the present invention. At block 33, an initial lexical profile for a target category is specified. The initial lexical profile comprises a set of one or more seed cues for a target category. The seed cues are words or phrases that one would expect to be found in a positive instance of a target category. Target categories can be such things as attrition risks, sales opportunities, product or service related problems or questions, or the like.

The concept recognition training system retrieves sentences from the training set that match lexical cues in the lexical profile, at block 35. The concept recognition training system parses the raw text into sentences and takes advantage of the fact that languages use sentences. The concept recognition training system separates interactions into sentences before human training is performed. For example, in an e-mail interaction, there may be eight total sentences where only two sentences give positive indications toward a specific concept or category. The concept recognition training system of the present invention uses a simple search to find matches to lexical cues. The concept recognition training system of the present invention retrieves only those sentences that match lexical cues in the lexical profile and ignores the sentences that do not match.

The system presents retrieved sentences to an analyst or trainer for auditing at block 37. The sentences are preferably presented in a graphical user interface in the order of their correspondence with the existing lexical profile. During auditing, the analyst or trainer reviews the list of retrieved sentences to determine whether or not the current lexical profile recognizes the concept reasonably well. The trainer does not need to be a skilled linguist. Rather, the trainer needs only to be able to determine whether a sentence conveys a particular concept. As the trainer determines the correspondence of sentences to the concept, the lexical profile is updated incorporating the matches that have been revealed through the auditing actions. Generally, the current lexical profile recognizes the concept reasonably well when there are relatively few false positives. As indicated at decision block 39, when the trainer determines-that the current lexical profile is complete enough to recognize the target category acceptably well, training is finished and the lexical profile for the target category is published, at block 41. If, at decision block 39, training is not finished, then the system prompts the analyst to select positive instances of the target category in the retrieved samples, at block 43. The selection may be through any of several well known graphical controls such as check boxes or the like. Alternatively, the trainer may use a graphical user interface control to deselect negative instances of the target category. In any event, the result of the selection step is a set of positive instances.

After the trainer has selected positive instances of the target category, at block 43, the concept recognition training system of the present invention automatically extracts lexical cues from the selected positive instances, at block 45. Automatic extraction according to the present invention is based upon testing the significance of particular words and phrases to determine those words and phrases that are found in a set of positive examples in the training set with frequencies that are much greater than would be expected by chance. In the preferred embodiment, significance of a given word or phrase is determined using a statistical test of independence against a null hypothesis that a given lexical item occurred with a particular distribution out of shear chance. For example, a Dunning's −2 log likelihood measure, which is described in Dunning, “Accurate Methods for the Statistics of Surprise and Coincidence”, Computational Linguistics, Volume 19, No. 1 (March 1993) (MIT Press) may be used as the basic measure, applied in a manner analogous to a chi-squared test. The test for independence determines which co-locations are significant enough to be regarded as lexical items in their own right. Where to set the threshold for rejecting such null hypotheses is one parameter that can be manipulated in optimizing the system. Lowering the threshold yields more cues, but such cues would likely be less reliable.

Each extracted lexical cue is given a weight reflecting its strength of association with a target category, at block 47. Preferably the weight is assessed as the mutual information between the lexical cue and the target category within the training set. The mutual information value is calculated from the conditional probability distribution for occurrences of the cue with respect to the semantic content with respect to the target category. After assigning weights at block 47, new lexical cues are added to the lexical profile at block 49, at processing returns to block 35.

Thus, in FIG. 2 processing, the training set and the lexical profile inform each other and the process of training reiterates between the two until the trainer is confident that the profile is complete enough to recognize the target category acceptably well. When the trainer is confident, then the lexical profile for the target category is published, at block 41.

The real-time system uses the published lexical profile for a particular target category as the basis for categorizing text. Nearly all categorization algorithms rely on characterizing a given input on the basis of a weighted vector called a feature space. The set of lexical cues in the lexical profile serves to characterize just such a space. Virtually any standard text categorization algorithm can be used to categorize the text on the basis of the feature space derived here. Such categorization is preferably normalized to reflect a confidence score in the range of zero to 100, thereby making it easier for unsophisticated users to understand. The normalization also separates the application from the actual details of the classification algorithm used.

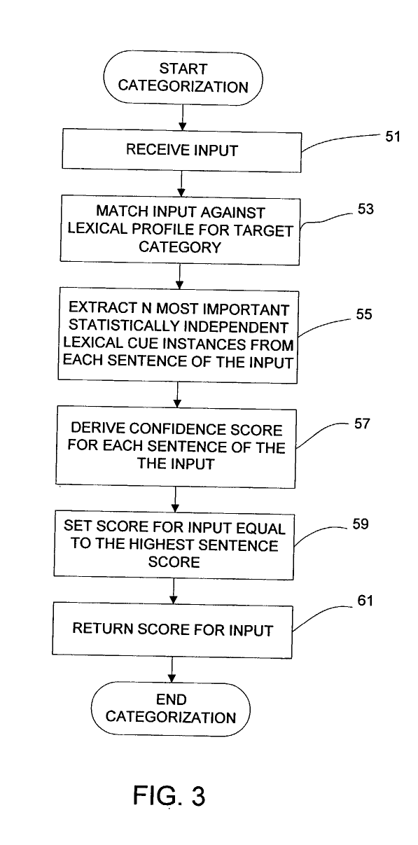

A flowchart of a categorization algorithm is illustrated in FIG. 3. An input is received at block 51. The input is matched against the lexical profile for the target category at block 53. The real-time system applies a heuristic to extract the N most important statistically independent lexical cue instances from each sentence of the input, as indicated at block 55. In the preferred embodiment, N is set equal to three. The real-time system then derives a confidence score for each sentence of the input, as indicated at block 57. In the preferred embodiment the confidence score represents the sum of the mutual information values for the lexical cue instances. The score is calculated according to a sigmoidal function as follows:

score′=2^{sigmoid(I}^{ₛ}^{,P}^{_{c}}^{)-bits}^{_{—}}^{to}^{_{—}}^{resolve(P}^{_{c}}⁾

Where:

Iₛ=the score derived for sample S

P_{c}=the prior probability of category C

bits_to_resolve(P_{c})=−log₂(P_{c})

sigmoid(Iₛ,P_{c})=[an approximation of Iₛ in the range 0 . . .

$$bits\_to \_resolve ( {P}_{c} ) ] = bit\_to \_resolve ( {P}_{c} ) \cdot \frac{1}{1 + {2}^{- {log}_{2} ( \frac{{I}_{s}^{B}}{bits\_to \_resolve ( {P}_{c} )} )}}$$

B is a heuristically determined base equal to or less than 2.

The sigmoidal function ensures that all resulting scores will lie between zero and 100 to cover cases where the cumulative score S is larger than the number of bits to be resolved. After deriving the confidence score, the real-time system sets the score for the input equal to the highest sentence score at block 59, and returns a score for the input, at block 61. The score may then be used as a measure of strength of association with the target category or concept.

From the foregoing, it may be seen that the present invention overcomes the shortcomings of the prior art. The concept recognition training system may be used by a trainer that is not a linguist. The trainer need only be able to recognize whether or not a sentence conveys the target concept. The initial lexical profile with a relatively few seed cues retrieves enough sentences from the relatively small training set to provide a starting point for statistical analysis. The system reiteratively enhances the lexical profile until the trainer is satisfied with its performance.

What is claimed is:

1. A method of recognizing a concept, which comprises:
(a) specifying a training set;
(b) specifying a lexical profile for a target category, said lexical profile comprising a set of seed lexical cues;
(c) retrieving samples from the training set that match lexical cues in said lexical profile;
(d) selecting positive instances of said target category from retrieved samples;
(e) extracting lexical cues from said selected positive instances; and,
(f) adding extracted new lexical cues to said lexical profile.

2. The method as claimed in claim 1, including:
repeating steps (c) through (f) until a desired confidence level in the lexical profile for the target category is achieved.

3. The method as claimed in claim 2, including:
publishing the lexical profile for the target category.

4. The method as claimed in claim 1, wherein said step of extracting lexical cues includes identifying words and phrases in said positive instances having a frequency distribution greater than that expected by chance.

5. The method as claimed in claim 1, wherein said step of selecting positive instances of said target category from retrieved sentences comprises:
displaying said retrieved samples to an analyst; and,
prompting said analyst to select displayed samples that represent positive instances of said target category.

6. The method as claimed in claim 5, wherein said retrieved samples are displayed in order of their respective correspondence with the lexical profile.

7. The method as claimed in claim 1, including assigning to each lexical cue a weight reflecting a strength of association of said each lexical cue with said target category.

8. The method as claimed in claim 7, wherein said strength of association is assessed as mutual information between said each lexical cue and said target category with said training set.

9. The method as claimed in claim 1, wherein said retrieved samples consist of sentences.

10. The method as claimed in claim 9, including:
repeating steps (c) through (f) until a desired confidence level in the lexical profile for the target category is achieved.

11. The method as claimed in claim 9, wherein said step of extracting lexical cues includes identifying words and phrases in said positive instances having a frequency distribution greater than that expected by chance.

12. The method as claimed in claim 9, wherein said step of selecting positive instances of said target category from retrieved sentences comprises:
displaying said retrieved sentences to an analyst; and,
prompting said analyst to select displayed sentences that represent positive instances of said target category.

13. The method as claimed in claim 1, including scoring an input based upon correspondence between said input and said lexical profile.

14. The method as claimed in claim 13, wherein said scoring includes:
matching an input against said lexical profile.

15. The method as claimed in claim 14, including:
extracting lexical cue instances from said input.

16. The method as claimed in claim 15, wherein said extracting lexical cue instances from said input includes:
extracting a predefined number of most important statistically independent lexical cue instances from each sentence of said input.

17. The method as claimed in claim 16, including:
deriving a confidence score for each sentence of said input.

18. The method as claimed in claim 17, including:
setting a score for said input equal to a highest sentence score for said input.

19. The method as claimed in claim 1, wherein said specifying a training set includes:
selecting a set of specimens from an input stream.

20. A concept recognition system, which comprises:
a concept recognition training system for generating a lexical profile for a target category from a training set, said lexical profile including an initial set of seed lexical cues;
a real-time system for scoring input text based upon correspondence of said input text with said lexical profile.

21. The concept recognition system as claimed in claim 20, wherein said concept recognition training system includes:
means for retrieving samples from said training set that match lexical cues in said lexical profile;
means for displaying said retrieved samples to an analyst;
means for prompting said analyst to select positive instances of said target category form said retrieved sample;
means for extracting lexical cues from said selected positive instances; and,
means for adding extracted new lexical cues to said lexical profile.

22. The system as claimed in claim 21, wherein said means for extracting lexical cues includes:
means for identifying words and phrases in said positive instances having a frequency distribution greater than that expected by chance.

23. The system as claimed in claim 21, including:
means for assigning to each lexical cue in said training set a weight reflecting a strength of association of said each lexical cue with said target category.

24. The system as claimed in claim 21, including:
means for publishing said lexical profile to said real-time system when the lexical profile achieves a desired confidence level.

25. The system as claimed in claim 20, wherein said real-time system includes:
means for matching an input text against said lexical profile.

26. The system as claimed in claim 25, including:
means for extracting lexical cue instances from said input text.

27. The system as claimed in claim 26, wherein said means for extracting lexical cue instances from said input text includes:
extracting a predefined number of most important statistically independent lexical cue instances from each sentence of said input text.

28. The method as claimed in claim 27, including:
means for deriving a confidence score for each sentence of said input text.

29. The method as claimed in claim 28, including:
means for setting a score for said input text equal to a highest sentence score for said input text.

30. A method of developing a lexical profile for recognizing a concept, which comprises:
administering a lexical profile for said concept; and,
auditing a training set.

31. The method as claimed in claim 30, wherein administering said lexical profile includes:
specifying an initial lexical profile, said initial profile comprising a set of seed lexical cues.

32. The method as claimed in claim 31, wherein auditing a training set includes:
using said initial lexical profile to retrieve samples from said training set.

33. The method as claimed in claim 32, wherein said administering said lexical profile further includes:
selecting positive instances of said concept from said retrieved samples.

34. The method as claimed in claim 33, wherein said administering said lexical profile further includes:
extracting lexical cues from said selected positive instances; and,
adding newly extracted lexical cues to said lexical profile.
